(19) United States
(12) Patent Application Publication
(10) Pub. No.: US 2003/0001982 A1
(43) Pub. Date: Jan. 2, 2003

(54) Display device

(75) Inventor: Eddie Chang, Hong Kong (HK)

Correspondence Address: Thomas E. Sisson, Jackson Walker L.L.P., Suite 2100, 112 E. Pecan Street, San Antonio, TX, 78205, US

(73) Assignee: Man Nin Shing Company Limited

(21) Appl. No.: 09/893,052

(22) Filed: Jun. 27, 2001

(51) Int. Cl. G02F 1/1333

(52) U.S. Cl. 349/58

(57) ABSTRACT

The invention comprises a display unit having a base, and a liquid crystal display device mounted on the base. The base and panel are configured so that the panel is able, in use, to form the panel of a holder or container.

### BACKGROUND OF THE INVENTION

With the increasing need in modem life for readily available information it is desirable that such useful information be displayed in as many places as possible. It is also desirable that such displays be aesthetically pleasing.

### OBJECT OF THE INVENTION

It is therefore an object of the present invention to provide a display unit and/or a holder and/or a container which will go at least some way towards meeting the foregoing desiderata in a simple yet effective manner or which will at least provide the public with a useful choice.

### STATEMENT OF THE INVENTION

Accordingly in one aspect the invention consists in a display unit having a base, a liquid crystal display device mounted on the base, the base and panel being configured so that the panel is able, in use, to form the panel of a holder or container, or to form a display panel adjacent a holder or container.

Preferably the base is hollow and contains control circuitry and power supply means for the display unit before the liquid crystal display device.

Preferably the base contains electrically conducting terminals for a battery.

In a further aspect invention consists in a holder including a display unit as described in the preceding paragraphs, the panel of the display unit forming a wall in the holder.

Preferably the holder includes a base, a recess in the underside of the holder base, a slot through the holder base from the recess, the display unit base being held in the recess and the display unit panel extending through the slot.

Preferably the holder base has a plurality of apertures therethrough and the control devices are provided on the display unit base, the control devices extending through the aperture.

In a still further aspect the invention consists in a container including a display unit as described in the preceding paragraphs, the container including one or more walls and the panel of the display unit forming one of the walls of the container.

Preferably the container includes a base, a recess in the underside of the container base, a slot through the container base from the recess, the display unit base being held in the recess and the display panel extending through the slot to the wall.

Preferably the container base has a plurality of apertures therethrough, control devices being provided on the display unit base and the control devices extending through the apertures.

A display unit having a base, having upper and lower faces, a slot in the base, a display unit and a control mechanism for the display unit, the control mechanism being mounted on the lower face of the base and the display unit being visible from the upper face of the base.

A display unit as claimed in claim 1, wherein a recess is provided in the lower face of the base and the control mechanism is mounted in the recess.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTON OF THE DRAWINGS

One preferred form of the invention will now be described with reference to the accompanying drawings in which,

FIG. 1 is an exploded view of a display unit according to the invention,

FIG. 2 is an exploded view of a display unit as shown in FIG. 1 assembled and showing in its exploded form its engagement with a holder base,

FIG. 3 is a perspective view of a holder according to one preferred form of the invention, and

FIG. 4 is a view of a container according to one preferred form of the invention.

### DESCRIPTION OF THE PREFERRED EMBODIMENT

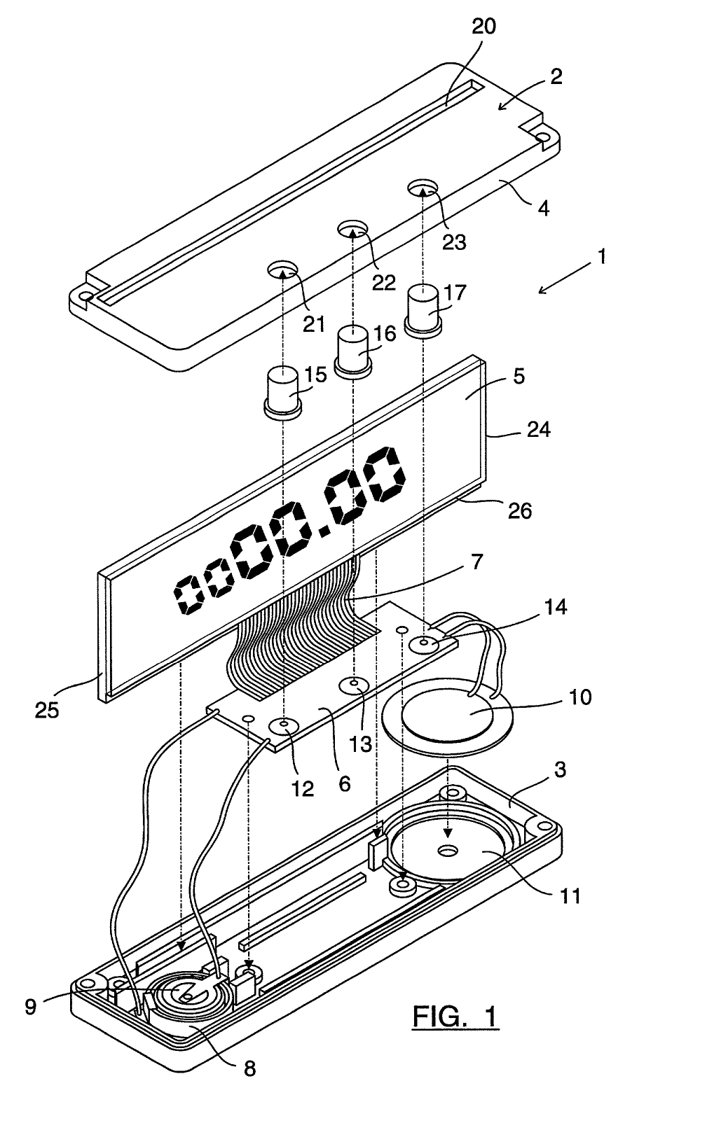

Referring to the drawings, a display unit 1 is provided having a base 2 which may be formed of a bottom part 3 and a top part 4 engageable one with the other to form the completed base. As can be seen from FIG. 1 the base is hollow and contains circuitry to control a liquid crystal display unit in the form of a panel 5. Thus the circuitry may have a printed circuit board 6, and a suitable connector strip 7 to the panel 5.

A suitable terminal arrangement 8 is provided to receive a battery 9 which provides a power source to the display unit 1, the printed circuit board 6 and other devices. A particular further device may comprise a buzzer or alarm 10 which also is contained within a recess 11 within the base 2. The circuitry is controlled by control buttons 12, 13 and 14 which may have covers 15, 16 and 17 thereon. The top cover 4 of the base 2 may have a slot 20 therein through which the display panel extends and a series of apertures 21, 22 and 23 through which the control button covers 15, 16 and 17 extend. The display unit shown in the example is a liquid crystal display clock but other displays could be provided if desired. For a clock the control buttons may control mode, time, date and other variables, for example, as common with LCD clocks currently available. The display panel may have a part 24 which rests on the material defining the slot 20, and a further part 25 which passes into the slot 20. As can be seen in FIG. 1, the part 25 extends beyond the edge 26 of the part 24.

A holder or container is provided and the holder or container comprises a base 30 having a slot 31 therein through which the liquid crystal display panel 5 extends. The slot 31 is provided from a recessed area 32 on the under side of the base 30 and apertures 33, 34 and 35 are provided in the base 30.

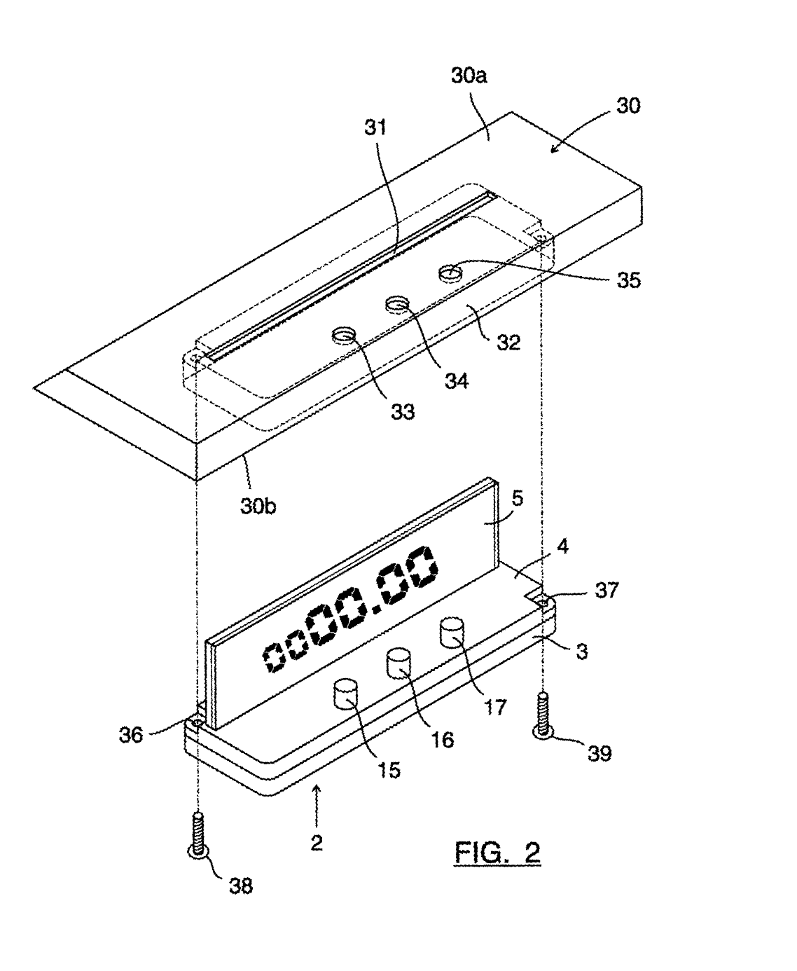

Apertures such as apertures 36 and 37 can be provided through the base 2 so that a fixing bolt or screw such as fixing bolts or screws 38 and 39 which engage the under side of the base 30 can be used to hold the base 2 in the recess and as shown in FIG. 2, to hold the parts 3 and 4 of the base together. Thus the base has upper and lower faces 30a and 30b, the recess being provided in the lower face 30b.

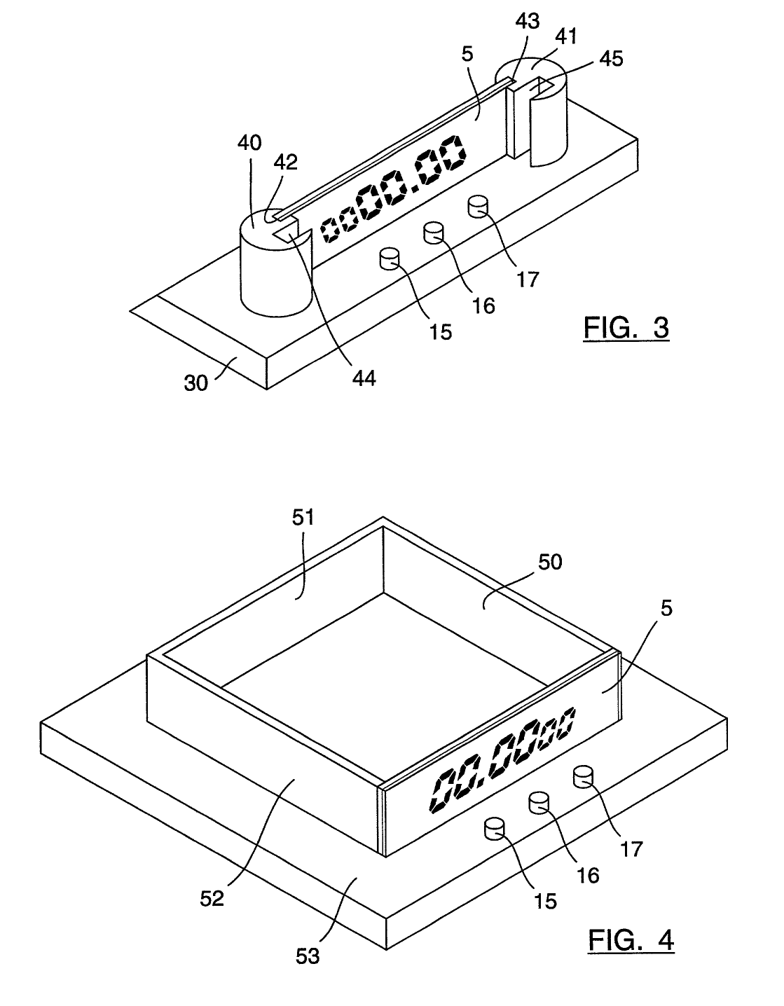

In FIG. 3 the base provides a holder and this is achieved in this example by providing two pillars 40 and 41 having slots 42 and 43 into which the panel 5 becomes positioned and two further slots 44 and 45 which can be used to hold any desired item, for example, business cards.

In the construction of FIG. 4 the panel 5 forms a wall or part of a wall which in the example given is completed by further walls 50, 51 and 52 mounted on a base 53. The base 53 is larger than the base 30, but otherwise is constructed substantially as shown in FIG. 2.

In use, the display unit, holder or container are used as above described to hold items such as for example, business cards or other cards or any desired items such as stationery items in a container.

1. A display unit having a base, a liquid crystal display panel mounted on the base, the base and panel being configured so that a panel is able, in use, to form the panel of a holder or container, or to form a display panel adjacent a holder or container.

2. A display unit as claimed in claim 1, wherein the base is hollow and contains control circuitry and power supply means for the liquid crystal display panel.

3. A display unit as claimed in claim 2, wherein the base contains electrically conducting terminals for a battery.

4. A display unit including a display unit as claimed in claim 1, wherein the panel of the display unit forms a wall in the holder.

5. A display unit as claimed in claim 4, wherein the holder includes a base, a recess in the underside of the holder base, a slot through the holder base from the recess, the display unit base being held in the recess and the display unit panel extending through the slot.

6. A display unit as claimed in claim 5, wherein the holder base has a plurality of apertures therethrough and the control devices are provided on the display unit base, the control devices extending through the aperture.

7. A display unit as claimed in claim 1, wherein the container includes one or more walls and the panel of the display unit forms one of the walls of the container.

8. A display unit as claimed in claim 7, wherein the container includes a base, a recess in the underside of the container base, a slot through the container base from the recess, the display unit base being held in the recess and the display panel extending through the slot to the wall.

9. A display unit as claimed in claim 8, wherein the container base has a plurality of apertures therethrough, control devices being provided on the display unit base and the control devices extending through the apertures.

10. A display unit having a base, having upper and lower faces, a slot in the base, a display unit and a control mechanism for the display unit, the control mechanism being mounted on the lower face of the base and the display unit being visible from the upper face of the base.

11. A display unit as claimed in claim 10, wherein a recess is provided in the lower face of the base and the control mechanism is mounted in the recess.
